(19) United States
(12) Patent Application Publication
(10) Pub. No.: US 2009/0154611 A1
(43) Pub. Date: Jun. 18, 2009

(54) METHODS AND APPARATUS FOR LOW OVERHEAD MSK DECODING

(76) Inventor: William C. Rogoza, Towson, MD (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/193,314

(22) Filed: Aug. 18, 2008

Related U.S. Application Data
(60) Provisional application No. 60/968,955, filed on Aug. 30, 2007.

(51) Int. Cl. H04L 27/06

(52) U.S. Cl. 375/343

(57) ABSTRACT

Methods and apparatus for receiving a signal having a intermediate frequency (IF), sampling the IF signal at a selected sampling frequency, correlating the sampled IF signal with a preamble signal, determining a correlation peak for the correlated signals, identifying chips of the preamble signal based upon the correlation peak, and decoding the IF signal to obtain and store information encoded in the IF signal.

### CROSS REFERENCE TO RELATED APPLICATIONS

The present application claims the benefit of U.S. Provisional Patent Application No. 60/968,955, filed on Aug. 30, 2007, which is incorporated herein by reference.

### BACKGROUND

As is known in the art, one technique to implement MSK demodulation includes down-converting a digitized IF (Intermediate Frequency) signal to base-band separated into I and Q, and then comparing the down-converted signals with a preamble pattern through a correlation process. This technique has a number of disadvantages including the use of many filters (which require multiplication), replication of hardware to account for sampling phases, e.g., 80 MHz, replication of hardware to process the I and Q channels independently, interpolation of the IF to 160 MHz, for example, correlation is at 32 MHz, for example, which is relatively low compared to 80 Mhz sampling rate, and no accommodation for overlapping signals (FRUIT—Friendly Returns Unsynchronized In Time)

### SUMMARY

The present invention provides methods and apparatus for low overhead MSK decoding by demodulating MSK signals directly from an IF signal without converting to base-band, i.e., eliminating processing of in phase and quadrature channel data. With this arrangement, by extracting data directly from sampled data, processing does not need to include interpolation, decimation, or de-rotation. While the invention is shown and described in conjunction with exemplary embodiments having particular signal characteristics, such as frequency, and applications, such as IFF, it is understood that embodiments of the invention are applicable to signal decoding in general in which is desirable to demodulate signals directly from an IF signal.

In one aspect of the invention, a method comprises receiving a signal having a intermediate frequency (IF), sampling the IF signal at a selected sampling frequency, correlating, using a computer processor, the sampled IF signal with a preamble signal, determining a correlation peak for the correlated signals, identifying chips of the preamble signal based upon the correlation peak, and decoding the IF signal to obtain and store information encoded in the IF signal.

In another aspect of the invention, a system comprises a receiver to receive an IF signal, a preamble correlator to correlate the received IF signal and a preamble signal to determine correlation peaks for identifying chips of the preamble signal based upon the correlation peak to enable decoding of the IF signal to obtain and store information encoded in the IF signal.

In a further aspect of the invention, method comprises performing MSK demodulation of a signal directly from an IF signal without conversion to base-band signals.

### BRIEF DESCRIPTION OF THE DRAWINGS

The foregoing features of this invention, as well as the invention itself, may be more fully understood from the following description of the drawings in which:

FIG. 1 is a block diagram of a demodulation system in accordance with exemplary embodiments of the invention;

FIG. 2 is a time domain representation of a 60 MHz IF for a preamble sampled at 80 MHz;

FIG. 3 is a graphical representation after performing correlation processing;

FIG. 3A is a graphical representation showing the result of IF signal phase shifting;

FIG. 4 is a graphical representation of converting the correlation function from voltage to power;

FIG. 4A is a graphical representation after expanding time around the correlation peak;

FIG. 5 is a graphical representation after applying a 20 MHz low pass filter;

FIG. 6 is a graphical representation showing the result of clock skew;

FIG. 7 is a graphical representation of noise performance;

FIG. 8 is a graphical representation of noise effects;

FIG. 9 is a graphical representation of two preamble pulse overlapped in time;

FIG. 10 is a graphical representation of two preamble individually extracted;

FIG. 11 is a flow diagram showing exemplary processing steps for MSK demodulation.

### DETAILED DESCRIPTION

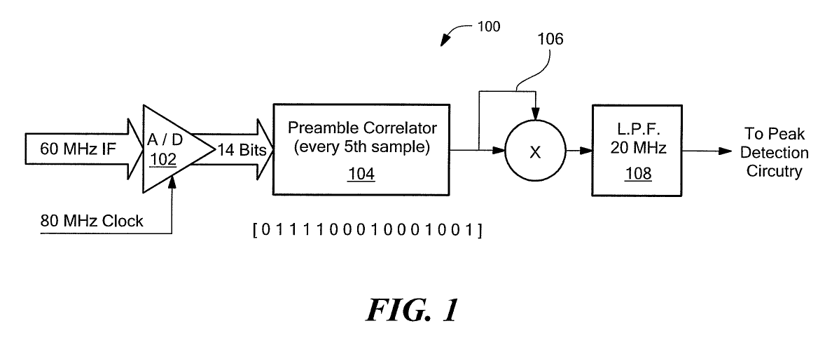

FIG. 1 shows a system 100 for low overhead MSK demodulation in accordance with exemplary embodiments of the invention. An analog-to-digital (A/D) converter 102 receives an input signal, at 60 MHz for example, and provides a digitized output signal to a preamble correlator module 104 the output of which is processed 106 and filtered 108, as described more fully below.

While exemplary embodiments are shown and described in conjunction with IFF (identify friend or foe) applications, and in particular, the Mode 5 IFF applications, which have particular characteristics, frequencies, etc., it is understood that the invention is applicable to waveform decoding applications in general for which it is desirable to demodulating MSK signals directly from the IF signal without converting to base-band. That is, the need to process I and Q channels separately is eliminated. Further, upon extracting the data directly from the sampled data, the need to interpolate, decimate, de-rotate and account for sampling phase shift can be eliminated.

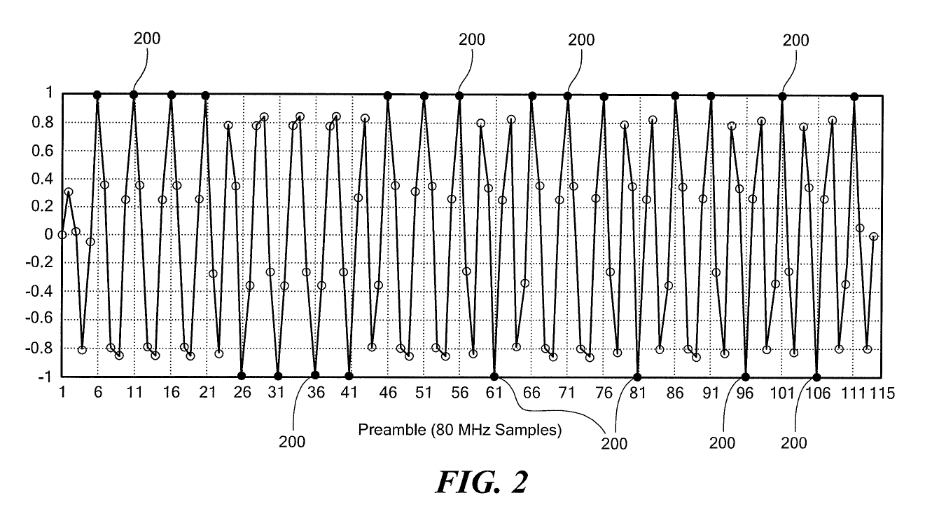

FIG. 2 is a time domain representation of the 60 MHz IF for a Mode 5 preamble sampled at 80 MHz. Note that the preamble chips can be directly read from the IF by looking at the solid dots 200. Directly reading every 5^{th} sample (80 MHz sample rate for a 16 MHz date rate) shown by the shaded dots one gets:

[1 1 1 1 −1 −1 −1 −1 1 1 1 −1 1 1 1 −1 1 1 −1 1 −1 1]

[X X X 0 1 1 1 1 0 0 0 1 0 0 0 1 0 0 1 X X X]

The above is determined from the dots 200 where dots at the ‘top’ are “1” and dots at the bottom are “−1” as shown in FIG. 2. A “1” corresponds to a “0” and a “−1” corresponds to a “1” to derive the bottom line above. It is understood that the results of FIG. 2 are for an artificial condition in which there is a perfect phase match, i.e., data is shifted to match the phase.

This pattern remains present even as the sample clock slews across the IF signal, although the pattern becomes more difficult to ‘see.’ One factor in successfully implementing the inventive decoding is selecting the proper sample(s) to use for the data extraction. Because the Mode 5 preamble was selected to have good auto-correlation characteristics, one can use this property in selecting the sample point.

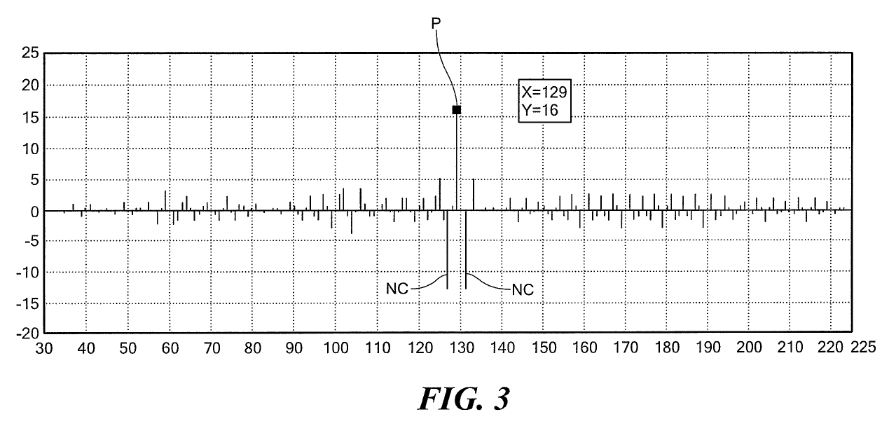

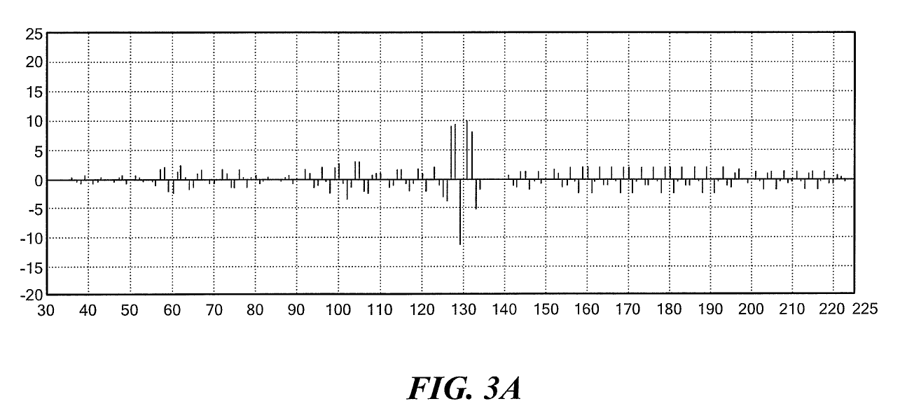

FIG. 3 shows, for the correlation between the 80 MHz IF and the M5 preamble (sampling shift zero), the expected peak P at sample 129 where all sixteen chips align. We can also see strong negative correlations NC (13 chips) two samples away on either side. At these points NC, the IF phase has shifted 180 degrees and is now the negative of the preamble. So one would expect that if the sample clock is shifted properly, the strongest correlation peak would be negative, and this is indeed what is seen in FIG. 3A. There is also another case where the phase relationship between the IF and the sample clock correlates equally well both positively and negatively.

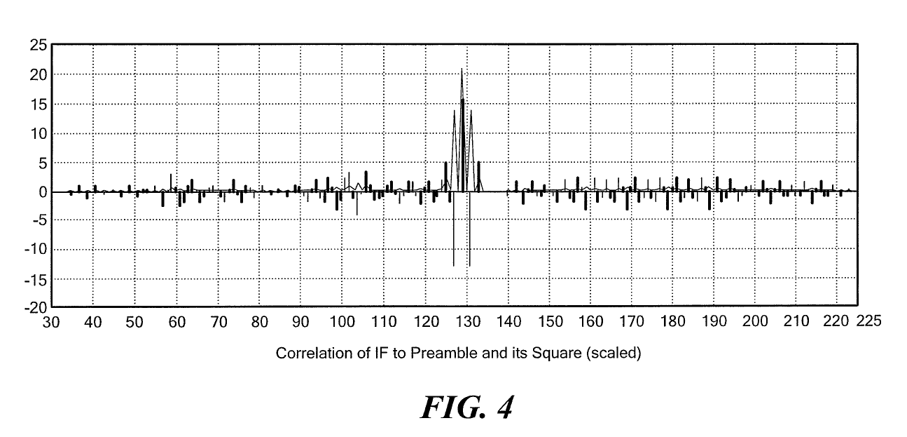

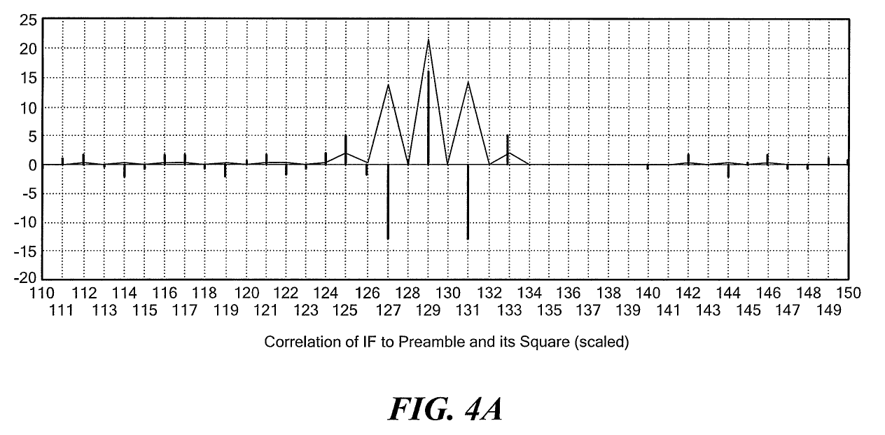

Since the phase relationship between the IF and the sample clock is unknown what we desire is the best match between the IF and the preamble in either a positive or negative direction. One technique to provide this one-sided correlation is to convert the correlation function from voltage to power, such as by squaring the correlation results. This technique seems to have a desirable secondary effect of expanding the results making the correlation peaks easier to “see,” as shown in FIG. 4. FIG. 4A shows the result of expanding time around the correlation peak.

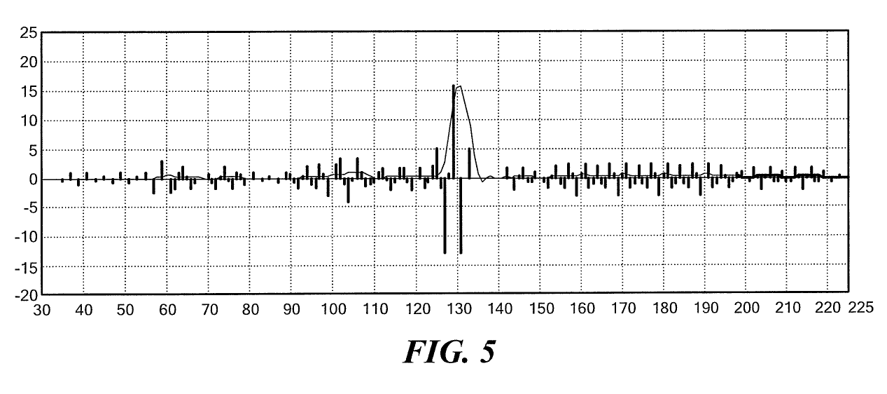

Referring now to FIG. 5, recalling that the sampling clock is still at 80 MHz, a signal of 20 Mhz is clearly present in the samples around the correlation peak (samples 124 through 134). This is as expected since the preamble is composed of roughly the same number of ones and zeros, on average its frequency shift is zero (7 bits at fₕ and 9 at fₗ). Since the IF at 60 MHz is under-sampled by the 80 MHz clock, the 60 MHz center frequency is aliased into 20 MHz. As there is little of interest in the 60 MHz carrier (20 Mhz), a 20 MHz low pass filter is applied to discard it.

The filter results in a delay of the correlation peak by about 2 clock ticks (25 ns) but this should be constant and removable. The correlation function is now well behaved and readily detectable with the 20 MHz products removed. Also note how the conversion to the power domain (squaring) has effectively reduced the signal in the areas of non-correlation.

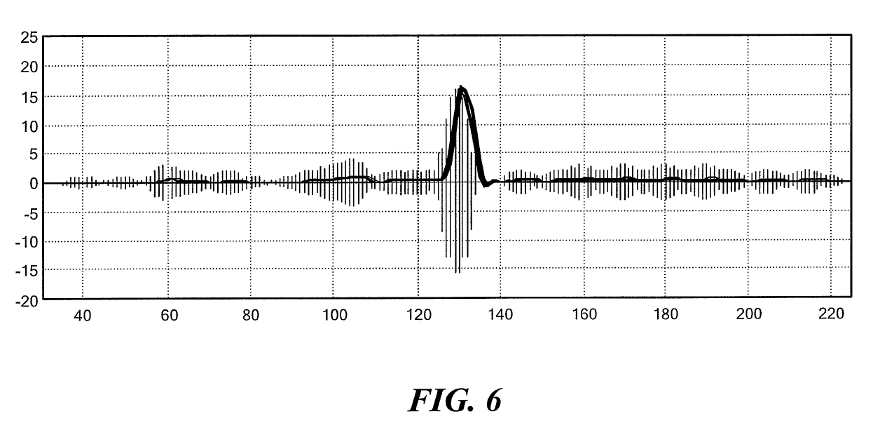

FIG. 6 shows what happens as the phase between the IF and the sample clock skew. The illustrative plot overlays the performance of the algorithm at 100 phase shifts between 0 and 360 degrees (3.6 degrees increments). While some variability in the correlation peak is apparent, this scheme is clearly tolerant of the incoherence between the sample clock and the IF signal.

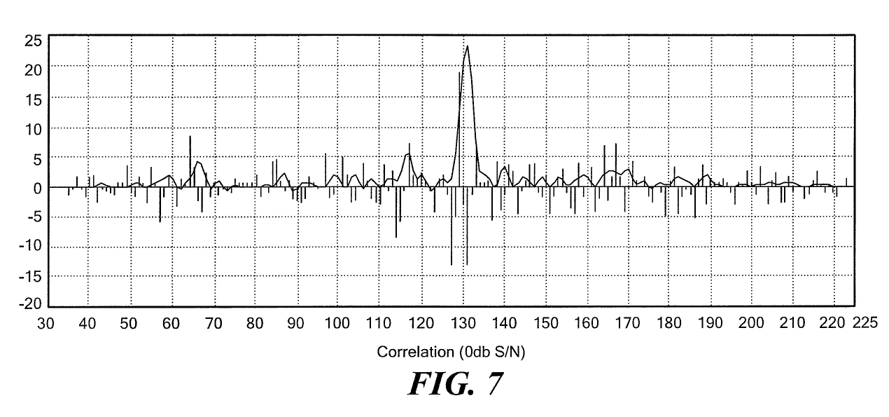

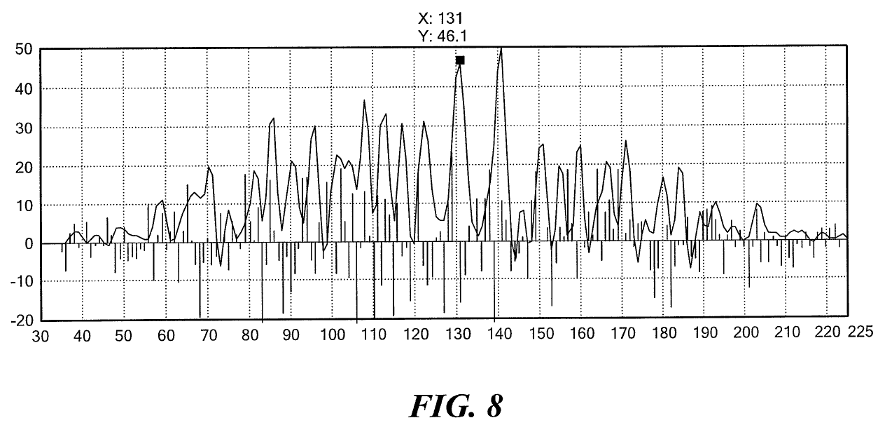

Noise performance is another component to be considered. The result of returning to a zero phase shift case and adding noise at 0 db S/N is shown in FIG. 7. The true correlation peak is still quite apparent although the noise effect can be clearly seen in the non-correlation areas. Somewhere around −12 db S/N the correlation peak becomes lost, as shown in FIG. 8.

Once the chip timing has been established by the preamble pulse, the circuit ‘knows’ where to sample the IF to extract any given chip value (zero or one). Once extracted, these chip values can be de-walshed, i.e., use Walsh transform processing, with simple (one bit wide) circuitry rather than a conventional multi-valued scheme. Once this is accomplished, consideration can be given to de-interleaving overlapping Mode 5 replies. Since the data can be extracted in parallel, it is possible to extract multiple data sets per reply (report) time.

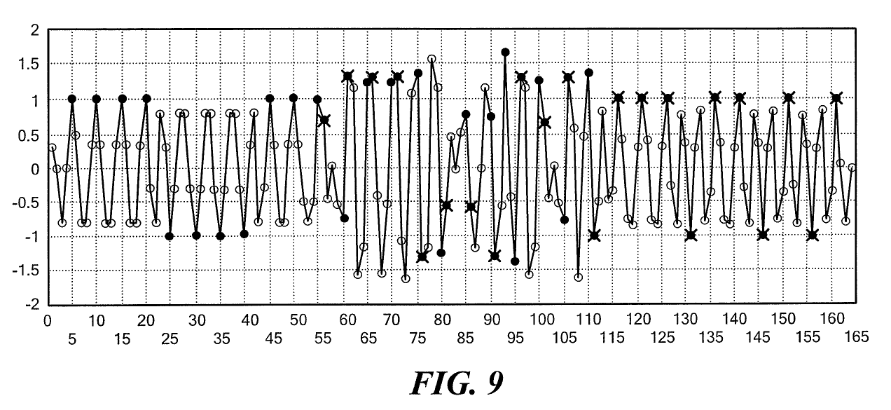

FIG. 9 shows first and second preamble pulses overlapped in time by about 50%. The data for the two signal can be seen in the time domain IF and is indicated by the solid red and green dots, wherein the green dots are X′d.

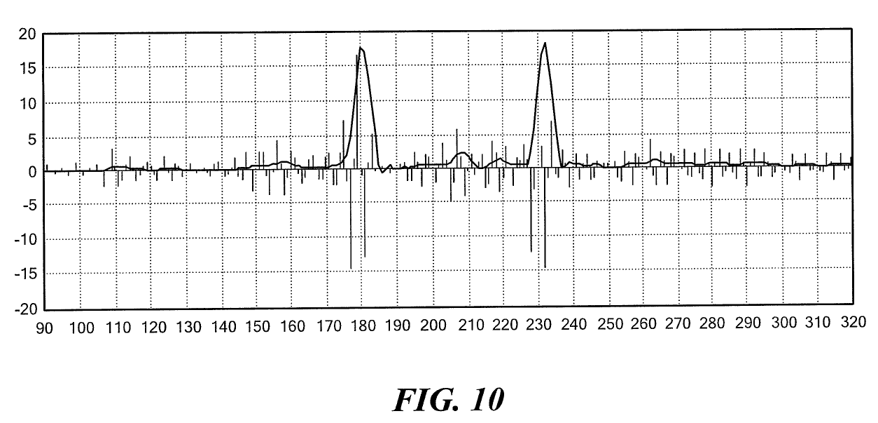

FIG. 10 demonstrates how the two overlapping preambles can be individually extracted. Once the preambles are extracted, the data symbols can be readily extracted.

It is believed that it should be possible to detect (decode) as many as five overlapping signals, without degradation, as long as they fall into different (80 Mhz) sampling bins. When overlapping signals fall into the same bins the effect is that of added noise. Depending on the amount of overlap it still may be possible to extract both signals.

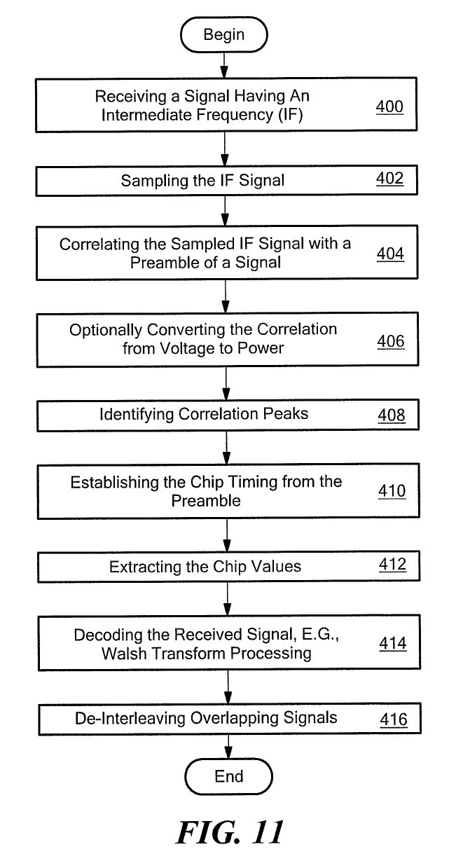

FIG. 11 shows an exemplary sequence of steps for MSK demodulation in accordance with exemplary embodiments of the invention. In step 400, an IF signal is received and in step 402, the received IF signal is sampled. In step 404, the sampled signal is correlated with a preamble of a signal. The correlation processing can optionally include converting the correlation from voltage to power in step 406. In step 408, correlation peaks are identified to establish chip timing of the preamble in step 410. In step 412, the chip values are extracted and received signal is decoded in step 414. In step 416, in case of multiple overlapping signals, the overlapping signals can be de-interleaved.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
receiving a signal having a intermediate frequency (IF);
sampling the IF signal at a selected sampling frequency;
correlating, using a computer processor, the sampled IF signal with a preamble signal;
determining a correlation peak for the correlated signals;
identifying chips of the preamble signal based upon the correlation peak; and
decoding the IF signal to obtain and store information encoded in the IF signal.

2. The method according to claim 1, wherein the correlation peak can be negative due to a relationship of a phase of the sampling frequency and the IF signal.

3. The method according to claim 1, wherein the preamble signal includes a Mode 5 IFF preamble.

4. The method according to claim 1, further including converting the correlation from voltage to power by squaring an output of the correlation.

5. The method according to claim 1, further including using Walsh transform processing to decode the IF signal.

6. The method according to claim 1, further including de-interleaving overlapping preamble pulses.

7. The method according to claim 1, further including up to five overlapping signals falling into different sampling bins.

8. The method according to claim 1, wherein the IF is about 60 MHz and the sampling frequency is about 80 MHz.

9. A system, comprising:
a receiver to receive an IF signal;
a preamble correlator to correlate the received IF signal and a preamble signal to determine correlation peaks for identifying chips of the preamble signal based upon the correlation peak to enable decoding of the IF signal to obtain and store information encoded in the IF signal.

10. The system according to claim 9, wherein the correlation peak can be negative due to a relationship of a phase of the sampling frequency and the IF signal.

11. The system according to claim 9, wherein the preamble signal includes a Mode 5 IFF preamble.

12. The system according to claim 9, wherein the preamble correlator converts the correlation from voltage to power by squaring an output of the correlation.

13. The system according to claim 9, wherein the preamble correlator de-interleaves overlapping preamble pulses.

14. The system according to claim 9, wherein the IF is about 60 MHz and the sampling frequency is about 80 MHz.

15. A method comprising:
performing MSK demodulation of a signal directly from an IF signal without conversion to base-band signals.

16. The method according to claim 15, further including identifying correlation peaks for the IF signal and a preamble signal.

17. The method according to claim 15, further including using the correlation peaks to identify signal chips and perform identify friend or foe processing.

18. The method according to claim 15, wherein the IF signal is a Mode 5 IFF signal.
